(19) United States
(12) Patent Application Publication
(10) Pub. No.: US 2015/0178772 A1
(43) Pub. Date: Jun. 25, 2015

(54) USER CONTROL OF TARGETED ADVERTISING

(71) Applicant: THOMSON LICENSING, Issy de Moulineaux (FR)

(72) Inventors: Anmol Nalin SHETH, San Francisco, CA (US); Udi WEINSBERG, Menlo Park, CA (US); Jaideep CHANDRASHEKAR, Paris (FR); Bin LIU, Los Angeles, CA (US)

(73) Assignee: THOMSON LICENSING, Issy de Moulineaux (FR)

(21) Appl. No.: 14/134,056

(22) Filed: Dec. 19, 2013

(51) Int. Cl. G06Q 30/02; H04L 29/08

(52) U.S. Cl. CPC G06Q 30/0255; H04L 67/22; G06Q 30/0269

(57) ABSTRACT

A web advertisement classifier for embedded advertisements in a web page includes detecting whether an advertisement is a contextual advertisement; detecting whether the advertisement is a retargeted advertisement; and detecting whether the advertisement is a behaviorally targeted advertisement. Classified advertisement suppression is provided that includes identifying one or more previously-visited web pages; visiting the one or more web pages chronologically identifying one or more target web pages having a content association that is a same content association had by the advertisement; skipping the one or more target web pages; and saving the resultant click stream.

### BACKGROUND

Today's online advertising ecosystem is driven by the ubiquitous tracking of end users' engagement with websites and services. Advertisements are selected to match an end user's interests based on profiles mined by tracking services. One feature of such existing systems is that end users, the presumed beneficiaries, have little control over the data that is collected by such tracking services, or how such data is targeted. While some tracking services expose a user's profile and allow it to be edited, a majority of such tracking services do not do so, and little is known about how such tracking services operate. And even in systems where a user's profile is exposed, such systems do not allow the user to reason about why they are being presented with a particular advertisement.

### SUMMARY

A method is provided for enabling greater transparency by allowing a user to reason about a particular advertisement displayed on a web page he or she is visiting. The method also grants users fine grained control wherein they can suppress advertisements targeting a particular category.

The method includes detecting whether an advertisement is a contextual advertisement; detecting whether the advertisement is a retargeted advertisement; and detecting whether the advertisement is a behaviorally targeted advertisement. The detecting whether the advertisement is a contextual advertisement includes disabling an identifying profile associated with the user; browsing the web page on which the advertisement was embedded while the identifying profile is disabled; and determining whether the advertisement is presented on the web page while the identifying profile is disabled. The detecting whether the advertisement is a retargeted advertisement includes identifying one or more previously visited web pages, the previously-visited web pages having a domain associated therewith; and determining whether a domain associated with the advertisement matches one of the domains associated with the one or more previously-visited web pages. The detecting whether the advertisement is a behaviorally targeted advertisement includes determining that the advertisement is not a contextual advertisement and is not a retargeted advertisement.

Also disclosed is a method of suppressing classified advertisements on a web page. The method includes identifying one or more previously-visited web pages, which were visited prior to encountering an advertisement on a current web page; visiting the one or more web pages chronologically; identifying one or more target web pages from the one or more web pages, the one or more target web pages having a content association that is a same content association had by the advertisement; skipping the one or more target web pages in chronology; and saving a resultant click stream associated with the visiting of the one or more previously visited web pages while skipping the one or more target web pages.

### BRIEF DESCRIPTION OF THE DRAWINGS

For a more complete understanding of the present invention, reference is made to the following detailed description of an embodiment considered in conjunction with the accompanying drawings, in which:

FIG. 1 is a diagram of a system configured to perform web advertisement classification and suppression in accordance with an embodiment of the present invention;

FIG. 2 is a flow chart showing a method of classifying web advertisements in accordance with an embodiment of the present invention;

FIG. 3a is a flow chart showing a method of suppressing classified advertisements in accordance with an embodiment of the present invention; and

FIG. 3b is a flow chart showing a method of suppressing classified advertisements in accordance with another embodiment of the present invention.

### DETAILED DESCRIPTION

The present disclosure relates to a platform for allowing users to identify and control the advertisements appearing on their Internet web browsers. The platform enables greater transparency with respect to advertisements by allowing users to learn what elements of their Internet browsing led to the display of the advertisement in question. The platform also allows users to suppress advertisements of a particular category, rather than an all-or-nothing approach, thereby giving users fine-grained control over the advertisements they see while browsing the Internet.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Other elements can be implemented through the use of specifically-purposed devices, such as electronic display screens and audio-visual devices.

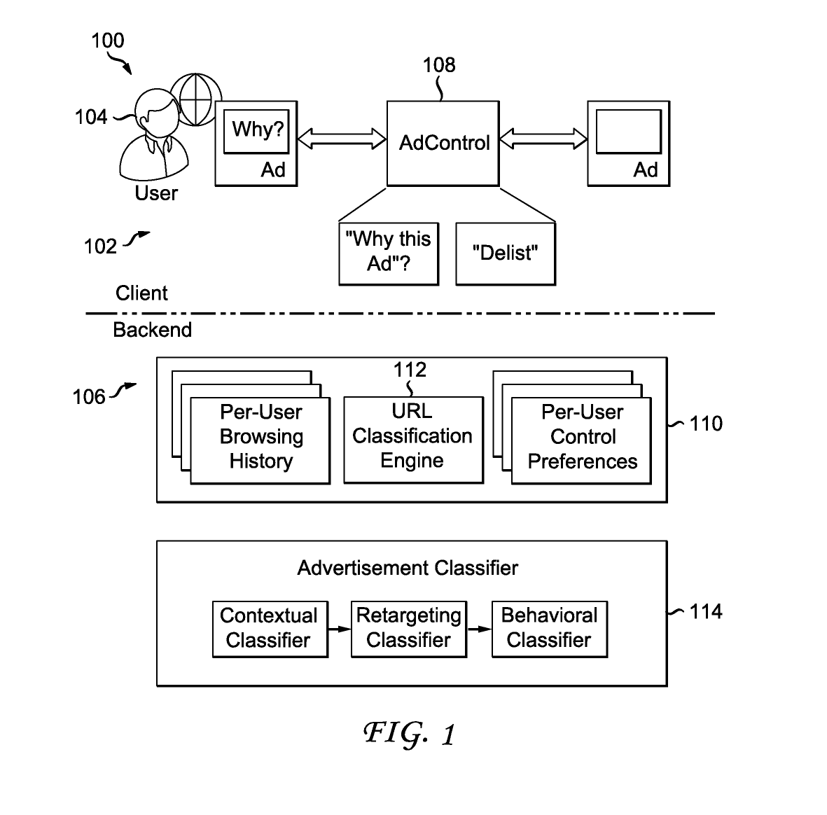

FIG. 1 illustrates a platform 100 constructed in accordance with an embodiment of the present invention. The platform includes two logical components: a client side 102 that monitors web transactions conducted by a user 104 and filters outgoing HTTP connections, and a backend 106 for analyzing web pages visited by the user and performing detailed characterizations of the web pages and the advertisements thereon. The client side 102 includes an advertisement control interface 108 to allow the user to execute the methods disclosed further below. The backend 106 includes a memory 110 for storing a user's browsing history and control preferences, which are associated with the user's profile, and a Universal Resource Locator (URL) classification engine 112 for investigating and classifying advertisements according to subject matter, such as, for example, “Loans→Mortgage” or “Recreation→Children's Toys.” The backend 106 also includes an advertisement classifier 114, which is configured to execute a number of processes for classifying an advertisement's type, such as, for example, contextual, retargeting, and behavioral. These processes are discussed in detail further below.

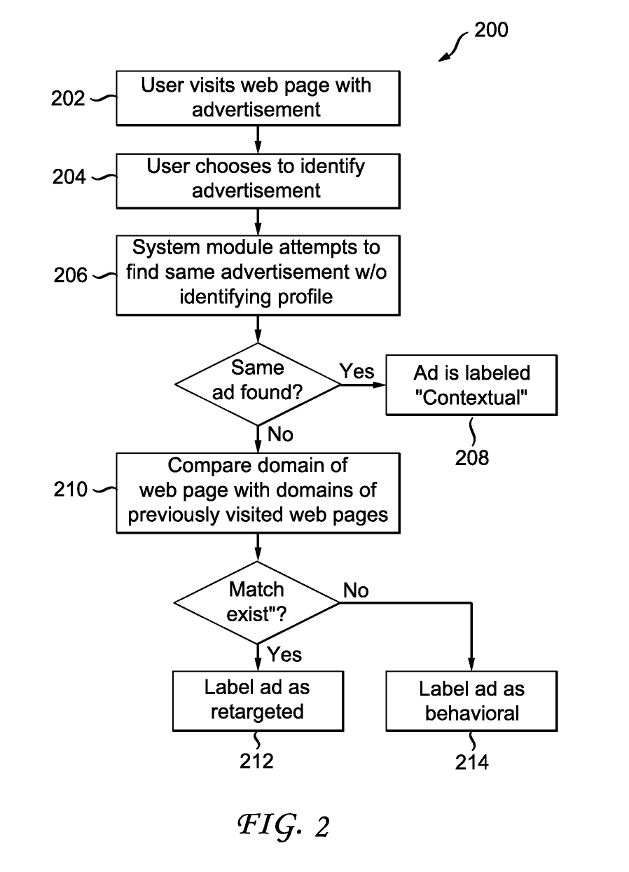

FIG. 2 illustrates a method 200 of classifying web advertisements in accordance with an embodiment of the present invention. The method begins when a user visits a web page (step 202) and is presented with an advertisement that the user 104 would like to investigate. The user initiates an identification procedure (step 204) on the advertisement. In one embodiment, the identification procedure 204 is deliberately activated by the user 104 through the use of a plugin. In another embodiment, the identification procedure (step 204) activates upon view of an advertisement without direction from the user 104.

Upon activation of the identification procedure, the advertisement classifier 114 tests whether the advertisement is a contextual advertisement, a re-targeting advertisement, or a behavioral advertisement. The advertisement classifier 114 begins by attempting to find the same advertisement that the user sees while browsing the web page without any identifying profile (step 206). In one embodiment, this test is performed K times consecutively. If the same advertisement is found at least once out of the K attempts, the advertisement classifier 114 determines that the advertisement is contextual and labels it as such (step 208).

If the advertisement classifier 114 determines that the advertisement is not contextual, it compares the domain of the web page embedding the advertisement with the domains of previously-visited web pages associated with the advertisement's ad-network or tracker (step 210). If a match exists between the domain of the embedded advertisement and one of the domains of the previously-visited web pages, the advertisement classifier 114 determines that the advertisement is re-targeted and labels it as such (step 212). If no match is found, the advertisement is assumed to result from behavioral targeting, and is thus labeled as behavioral (step 214).

In one embodiment, the advertisement classifier 114 indicates a category or associated subject matter, such as, for example, “Loans→Mortgage” or “Recreation→Children's Toys,” for an advertisement classified as behavioral. In one embodiment, the advertisement classifier 114 also provides to the user a link for “more information,” which leads the user to a page displaying the web pages in the user's history that are categorized with the same category associated with the advertisement in question.

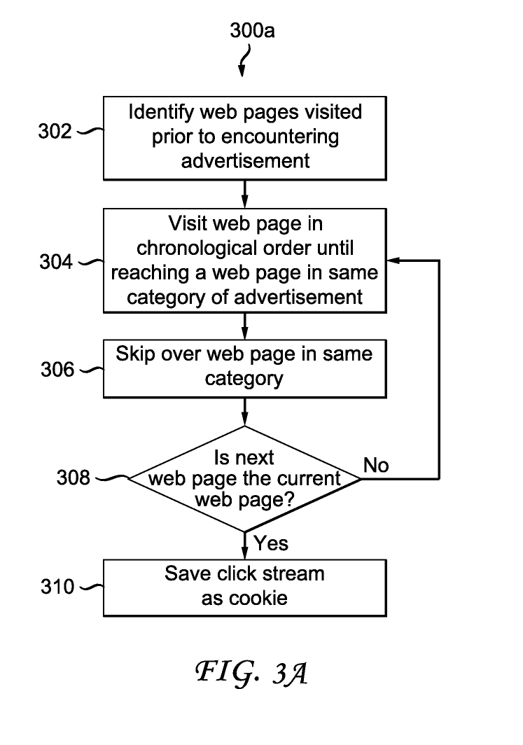

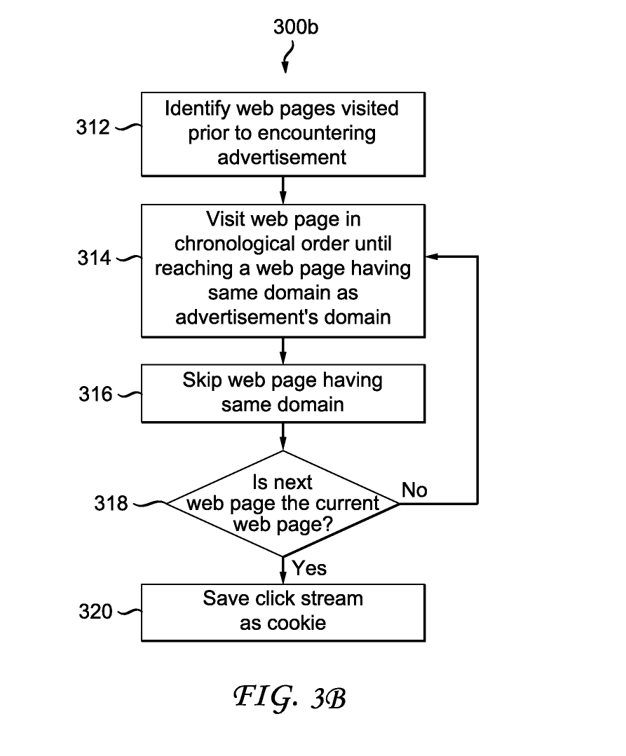

FIGS. 3a and 3b illustrate various methods 300a, 300b of suppressing advertisements from their particular category in accordance with embodiments of the present invention. With reference to FIG. 3a, in one embodiment with respect to suppressing behaviorally targeted advertisements, the advertisement classifier 114 identifies all web pages visited by the user up until the time the behaviorally targeted advertisement in question is encountered (step 302). The advertisement classifier 114 then visits these web pages in chronological order until it reaches a web page whose category matches the category of the behaviorally targeted advertisement (step 304). Any such web page is then skipped over (step 306), thereby avoiding the behavior associated with the behaviorally targeted advertisement. This process continues until the advertisement classifier 114 reaches the web page currently viewed by the user (step 308). The resultant click stream is then stored in a cookie for future use (step 310). A “click stream” is a term of art relating to data that represents selections or “clicks” by a user.

With reference to FIG. 3b, in one embodiment with respect to re-targeted advertisements, the advertisement classifier 114 identifies web pages visited by the user up until the time the retargeted advertisement in question is encountered (step 312). The advertisement classifier 114 then visits these web pages in chronological order until it reaches a web page whose domain matches the domain of the retargeted advertisement (step 314). Any such web page is then skipped over (step 316), thereby avoiding the original visit to the domain in question that resulted in the retargeted advertisement. This process continues until the advertisement classifier 114 reaches the web page currently viewed by the user (step 318). The resultant click stream is then stored in a cookie for future use (step 320).

To ensure that these user preferences are maintained, one embodiment of the present invention includes employing an online page classifier to block cookies from pages associated with the category that the user wishes to block. In one embodiment, the advertisement classifier 114 first allows only HTTP requests from the main body of the page to pass through to the user while blocking advertisement-related HTTP requests. The advertisement classifier 114 then scans the page category of advertisement-related HTTP requests and allows those which the user has not specifically chosen to avoid to pass through to the user. In this embodiment, HTTP requests whose categories match those categories associated with the saved cookies generated from the processes illustrated in FIGS. 3a and 3b are blocked until the user chooses to unblock them.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be understood that the embodiments described herein are merely exemplary and that a person skilled in the art may make many variations and modifications without departing from the spirit and scope of the invention. All such variations and modifications are intended to be included within the scope of the invention as defined in the appended claims.

1. A method of classifying a web advertisement embedded in a web page comprising:
detecting whether an advertisement is a contextual advertisement;
detecting whether the advertisement is a retargeted advertisement; and
detecting whether the advertisement is a behaviorally targeted advertisement.

2. The method of claim 1, wherein the detecting whether the advertisement is a contextual advertisement includes:
disabling an identifying profile associated with the user;
browsing a web page on which the advertisement was embedded while the identifying profile is disabled; and
determining whether the advertisement is presented on the web page while the identifying profile is disabled.

3. The method of claim 1, wherein the detecting whether the advertisement is a retargeted advertisement includes:
identifying one or more previously visited web pages, the previously visited web pages having a domain associated therewith; and
determining whether a domain associated with the advertisement matches one of the domains associated with the one or more previously-visited web pages.

4. The method of claim 1, wherein the detecting whether the advertisement is a behaviorally targeted advertisement includes determining that the advertisement is not a contextual advertisement and is not a retargeted advertisement.

5. A method of suppressing classified advertisements on a web page comprising:
identifying one or more previously-visited web pages which were visited prior to encountering an advertisement on a current web page;
visiting the one or more web pages chronologically;
identifying one or more target web pages from the one or more web pages, the one or more target web pages having a content association that is a similar content association had by the advertisement;
skipping the one or more target web pages in chronology; and
saving a resultant click stream associated with the visiting of the one or more previously visited web pages while skipping the one or more target web pages.

6. The method of claim 5, wherein the content association is a category of advertisement.

7. The method of claim 5, wherein the content association is a domain shared by the one or more targeted web pages.

8. A system for classifying web advertisements embedded in web pages browsed by a user, the system comprising:
a client side including an advertisement control interface configured to initiate an advertisement classification process, wherein the client side interfaces with a backend including a memory and a processor, the processor being configured to:
detect whether an advertisement embedded in a web page is a contextual advertisement;
detect whether the advertisement is a retargeted advertisement; and
detect whether the advertisement is a behaviorally targeted advertisement.

9. The system of claim 8, wherein the processor is further configured to disable an identifying profile associated with the user; browse the web page on which the advertisement was embedded while the identifying profile is disabled; and determine whether the advertisement is presented on the web page while the identifying profile is disabled.

10. The system of claim 9, wherein the processor is further configured to identify one or more previously visited web pages, the previously-visited web pages having a domain associated therewith; and determine whether a domain associated with the advertisement matches one of the domains associated with the one or more previously-visited web pages.

11. The system of claim 8, wherein the processor is further configured to:
identify one or more previously-visited web pages, which were visited prior to encountering the advertisement;
visit the one or more web pages chronologically;
identify one or more target web pages from the one or more web pages, the one or more target web pages having a content association that is a same content association had by the advertisement;
skip the one or more target web pages in chronology; and
save a resultant click stream associated with the visiting of the one or more previously visited web pages while skipping the one or more target web pages in the memory.
